(19) United States
(12) Patent Application Publication
(10) Pub. No.: US 2014/0162164 A1
(43) Pub. Date: Jun. 12, 2014

(54) METAL SEPARATOR FOR FUEL CELL, FUEL CELL STACK HAVING THE SAME AND GASKET ASSEMBLY WITH FUEL CELL STACK

(71) Applicant: Hyundai Motor Company, Seoul (KR)

(72) Inventor: Sang Mun Jin, Yongin (KR)

(73) Assignee: Hyundai Motor Company, Seoul (KR)

(21) Appl. No.: 14/103,315

(22) Filed: Dec. 11, 2013

(30) Foreign Application Priority Data
Dec. 12, 2012 (KR) 10-2012-0144840

(51) Int. Cl. H01M 8/24; H01M 8/02

(52) U.S. Cl. CPC H01M 8/2465; H01M 8/0273; H01M 8/0247; H01M 8/0206
USPC 429/463; 429/508; 429/514

(57) ABSTRACT

A fuel cell stack is provided which includes a gasket assembly interposed between the membrane-electrode assembly and an edge portion of the metal separator. In particular, the metal separator is formed of a first metal plate and a second metal plate welded to each other, and one or more curved portions, which are symmetrical to each other, formed around a welded portion of the first and second metal plates. The gasket assembly is then installed between a membrane-electrode assembly and the edge portion of the metal separator with the curved portion therebetween.

### CROSS-REFERENCE TO RELATED APPLICATION

This application claims priority to and the benefit of Korean Patent Application No. 10-2012-0144840 filed in the Korean Intellectual Property Office on Dec. 12, 2012, the entire contents of which are incorporated herein by reference.

### BACKGROUND

(a) Field of the Invention

The present invention relates to a fuel cell stack, and more particularly, to a metal separator for a fuel cell for improving air-tightness of a fuel cell, and a gasket assembly applied to the metal separator for the fuel cell.

(B) Description of the Related Art

In general, a fuel cell is a sort of a power generation system for directly converting chemical energy of fuel to electrical energy. Typically, a plurality of fuel cells, which are referred to as unit cells, are stacked to form a fuel cell stack, which creates an electricity generation assembly.

In operation, the fuel cell generates electrical energy via an electrochemical reaction between fuel and an oxidizer, and includes a membrane-electrode assembly (MEA), and separators disposed so as to be in close contact with both sides of the membrane-electrode assembly with the membrane-electrode assembly interposed therebetween.

The separator which is in close contact with an anode electrode of the membrane-electrode assembly may be defined as an anode plate, and the separator which are in close contact with a cathode electrode of the membrane-electrode assembly may be defined as a cathode plate.

The anode plate is provided with a fuel channel for supplying hydrogen as a fuel, to the anode electrode of the membrane-electrode assembly in one surface (hereinafter, referred to as a “reaction surface” for convenience of the description). The anode plate includes a cooling channel for distributing cooling medium in the other surface (hereinafter, referred to as a “cooling surface” for convenience of the description).

Likewise, the cathode plate is provided with an oxidizer channel for supplying air, which is an oxidizer, to the cathode electrode of the membrane-electrode assembly on one surface (hereinafter, referred to as a “reaction surface” for convenience of the description). The cathode plate is provided with a cooling channel for distributing cooling medium on the other surface (hereinafter, referred to as a “cooling surface” for convenience of the description).

The aforementioned anode plate and cathode plate may be provided with the fuel channel and the oxidizer channel on the respective reaction surfaces and the coolant channels on the respective cooling surfaces via press forming a metal plate. Here, the cooling channels formed on the cooling surfaces of the anode plate and the cathode plate are united together while the cooling surfaces of the anode plate and the cathode plate are in close contact with each other, so that a cooling passage through which cooling medium may flow between the anode plate and the cathode plate is formed.

In this case, one set in which the anode plate and the cathode plate are in close contact with each other may be defined as a metal separator for the fuel cell.

In the meantime, in order to configure a fuel cell stack by stacking a plurality of aforementioned fuel cells, air-tightness needs to be maintained between the reaction surfaces of the membrane-electrode assembly and the metal separator and between the cooling surfaces of the metal separators. To this end, a gasket may be formed between the reaction surfaces of the membrane-electrode assembly and the metal separator and between the cooling surfaces of the metal separators. This gasket is typically integrally injection molded at edges of both surfaces of the anode plate and the cathode plate.

However, the aforementioned method of injection molding of the gasket may deform the separator due to injection pressure and surface contamination of the separator generated during a crosslinking process, and also has a limitation in a design of a shape of the gasket, so it is difficult to improve air-tightness of the entire fuel cell stack.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a metal separator for a fuel cell capable of improving air-tightness with a simple configuration, improving productivity, and reducing failure of the separator.

In particular, an exemplary embodiment of the present invention provides a metal separator for a fuel cell disposed at both sides of a membrane-electrode assembly (MEA), in which the metal separator for the fuel cell is formed by welding first and second metal plates, which are initially separated from each other, to each other, and one or more curved portions, which are symmetrical to each other, are formed around a welded portion of the first and second metal plates.

Further, one surface of the first metal plate may be formed as a reaction surface having a first reaction gas channel, and the other surface may be formed as a cooling surface having a cooling channel. Additionally, one surface of the second metal plate may be formed as a reaction surface having a second reaction gas channel, and the other surface may be formed as a cooling surface having a cooling channel.

A cooling passage formed by unifying the cooling channels while the cooling surfaces of the first and second metal plates are welded to each other may be formed between the first and second metal plates. The curved portion may be formed so as to be curved toward the membrane-electrode assembly at edge portions of the reaction surfaces of the first and second metal plates. A plurality of curved portions may be formed at the edge portions of the reaction surfaces of the first and second metal plates. In the edge portions of the reaction surfaces of the first and second metal plates, regions between the curved portions may be welded to each other as well.

In another exemplary embodiment of the present invention, a fuel cell stack the makes up an electricity generation assembly by stacking a plurality of fuel cells in which the aforementioned metal separator is in close contact with both sides of a membrane-electrode assembly. In particular, the fuel cell stack includes a gasket assembly interposed between the membrane-electrode assembly and an edge portion of the metal separator. The metal separator is formed by welding a first metal plate and a second metal plate to each other. Additionally, one or more curved portions, which are symmetrical to each other, are formed around a welded portion of the first and second metal plates, and the gasket assembly is installed between the membrane-electrode assembly and the edge portion of the metal separator with the curved portion therebetween.

Further, the gasket assembly may include a frame formed of an insulation material, and a gasket integrally injection molded with the frame. Further, a plurality of the curved portions may be included at the edge portions of the first and second metal plates. The gasket may be disposed between the curved portions, and regions between the curved portions in edge portions of reaction surfaces of the first and second metal plates may be welded to each other.

In yet another exemplary embodiment of the present invention, a gasket assembly of a fuel cell stack making up an electricity generation assembly by stacking a plurality of fuel cells in which the aforementioned metal separator is in close contact with both sides of a membrane-electrode assembly. The gasket assembly is interposed between the membrane-electrode assembly and an edge portion of the metal separator, and includes a frame formed from an insulation material and gaskets integrally injection molded with both surfaces of the frame, in which at least one side surface of the gasket is in close contact with a curved portion of the metal separator, compressed when the fuel cell stack is coupled, and has a shape corresponding to a shape of the curved portion. Further, the frame may include a first portion disposed in a stack direction of the fuel cells, and a second portion connected with the first portion in a vertical direction. The frame may also have a cross-section shaped like a letter “T” in some embodiments of the present invention.

Further, the gaskets may be injection molded on upper and lower surfaces of the second portion and may be disposed between the membrane-electrode assembly and the edge portion of the metal separator with the curved portion formed at the edge portions of the first and second metal plates therebetween in the metal separator in which a first metal plate and a second metal plate are welded to each other.

According to the exemplary embodiment of the present invention, it is possible to configure the metal separator for the fuel cell by forming the curved portions, which are symmetrical to each other, at the edge portions of the first and second metal plates and welding the regions between the curved portions. In doing so, it is possible to further improve air-tightness of the cooling surface and the reaction surface of the metal separator for the fuel cell by welding the cooling surfaces of the first and second metal plates and forming the curved portions at the edge portions of the reaction surfaces of the first and second metal plates.

Further, according to the exemplary embodiment of the present invention, it is possible to maintain air-tightness of the fuel cells by separately forming the gasket assembly by a method of injection molding the gaskets in the frame, and interposing the gasket assembly between the edge portions of the first and second metal plates of the metal separator and the membrane-electrode assembly.

Accordingly, in the exemplary embodiment of the present invention, the gasket assembly is separately formed, so that it is possible to further improve rigidity and air-tightness of the fuel cells, prevent deformation, surface contamination, and the like of the metal separator present in the related art, reduce failure of the metal separator, and further improve productivity of the entire stack.

Further, in the exemplary embodiment of the present invention, the frame of the gasket assembly serves as a stopper when the fuel cells are stacked, so that it is possible to achieve external insulation of the metal separator and uniformity of a length of the stack.

### BRIEF DESCRIPTION OF THE DRAWINGS

The drawings are provided for reference in describing an exemplary embodiment of the present invention, so that it should not be construed that the technical spirit of the present invention is limited to the accompanying drawings.

FIG. 1 is a cross-sectional configuration diagram schematically illustrating a fuel cell stack according to an exemplary embodiment of the present invention.

FIG. 2 is a cross-sectional configuration diagram illustrating a metal separator applied to the fuel cell stack according to the exemplary embodiment of the present invention.

FIG. 3 is a partially cut perspective view of a gasket assembly applied to the fuel cell stack according to the exemplary embodiment of the present invention.

### DETAILED DESCRIPTION OF THE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present invention is not limited thereto. In the drawings, the thickness of layers, films, panels, regions, etc., are exaggerated for clarity.

Further, elements are termed a first . . . , a second . . . , and the like, in the detailed description below because the configurations of the elements are the same, and the names are not essentially limited to the order in the description below.

In the specification, unless explicitly described to the contrary, the word “comprise” and variations such as “comprises” or “comprising”, will be understood to imply the inclusion of stated elements but not the exclusion of any other elements.

In addition, the terms “- unit”, “- means”, “- part”, and “- member” described in the specification mean units of comprehensive configurations performing at least one function and operation.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid fuel cell vehicles, electric fuel cell vehicles, plug-in hybrid electric fuel cell vehicles, hydrogen-powered fuel cell vehicles, and other alternative fuel cell vehicles. As referred to herein, a hybrid vehicle is a vehicle that has two or more sources of power, for example both fuel cell-powered and electric-powered vehicles.

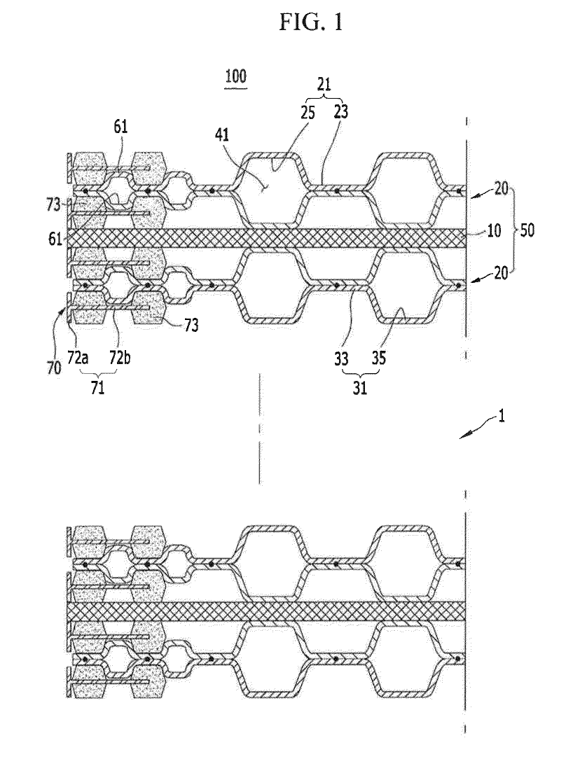

FIG. 1 is a cross-sectional configuration diagram schematically illustrating a fuel cell stack according to an exemplary embodiment of the present invention. Referring to FIG. 1, the fuel cell stack 100 according to the exemplary embodiment of the present invention includes an electricity generation assembly 1 for generating electrical energy by electrochemical reaction between fuel and an oxidizer which are reaction sources. For example, the fuel cell stack 100 may be applied to a fuel cell system applied to a fuel cell vehicle. Hereinafter, it is assumed that the fuel is hydrogen gas and the oxidizer is air.

Here, the fuel cell stack 100 may be formed of the electricity generation assembly 1 in which a plurality of fuel cells 50 (generally referred to as a “unit cell” in the art) is stacked. Each fuel cell 50 may be formed by arranging metal separators 20 for the fuel cell according to the exemplary embodiment of the present invention at both sides of a membrane-electrode assembly MEA 10.

Hereinafter, respective constituent elements are described with reference to the drawings, and vertically stacking the fuel cells 50 will be described as an example. However, a definition of the direction is a relative meaning, and the direction may be changed according to a direction in which the fuel cells 50 are stacked, and the aforementioned reference direction is not essentially limited as the reference direction for the exemplary embodiment of the present invention.

In the membrane-electrode assembly 10, an anode electrode and a cathode electrode are formed at both side surfaces of an electrolyte membrane, respectively. The membrane-electrode assembly 10 is a widely and publicly known technology in the art, so that a more detailed description of a configuration thereof in the present specification will be omitted.

The metal separator 20 for the fuel cell includes first and second metal plates 21 and 31. The first and second metal plates 21 and 31 may form passages, through which hydrogen gas and air flow, respectively, and a passage through which cooling medium (for example, a coolant) flows by a press process.

One surface of the first metal plate 21 may be formed as a reaction surface having a first reaction gas channel 23, through which hydrogen gas flows, and being in close contact with the anode electrode of the membrane-electrode assembly 10. The other surface of the first metal plate 21 may be formed as a cooling surface having a cooling channel 25, through which cooling medium flows.

Likewise, one surface of the second metal plate 31 may also be formed as a reaction surface having a second reaction gas channel 33, through which air flows, and being in close contact with the cathode electrode of the membrane-electrode assembly 10. The other surface of the second metal plate 31 may be formed as a cooling surface having a cooling channel 35, through which cooling medium flows.

A cooling passage 41 formed by unifying the cooling channels 25 and 35 while the cooling surfaces of the first and second metal plates 21 and 31 come into contact with each other is formed between the first and second metal plates 21 and 31.

In the meantime, the fuel cell stack 100 further includes a gasket assembly 70 for maintaining air-tightness between edge portions of the first and second metal plates 21 and 31 of the fuel cell 50 and the membrane-electrode assembly 10. The gasket assembly 70 may be interposed between the edge portions of the first and second metal plates 21 and 31 and the membrane-electrode assembly 10. The configuration of the gasket assembly 70 will be described in more detail below.

The fuel cell stack 100 according to the exemplary embodiment of the present invention having the aforementioned configuration has a structure capable of improving air-tightness of the entire stack by improving a coupling structure of the first and second metal plates 21 and 31 for the metal separator 20 for the fuel cell and a structure of the gasket assembly 70. As such, the fuel cell stack 100 according to the exemplary embodiment of the present invention has a structure capable of improving productivity, and reducing failure of the metal separator 20 for the fuel cell.

To this end, the metal separator 20 for the fuel cell in the exemplary embodiment of the present invention may be formed of a set of first and second metal plates 21 and 31 by for example laser welding the metal plates 21 and 31 in a state where the separated cooling surfaces of the first and second metal plates 21 and 31 are in close contact with each other. That is, the cooling channel 41 may be formed, in such a way that when external regions of the cooling channels 25 and 35 of the cooling surfaces of the first and second metal plates 21 and 31 are in close contact with each other, close contact portions thereof are welded by laser, so that the cooling channels 25 and 35 between the cooling surfaces are unified together.

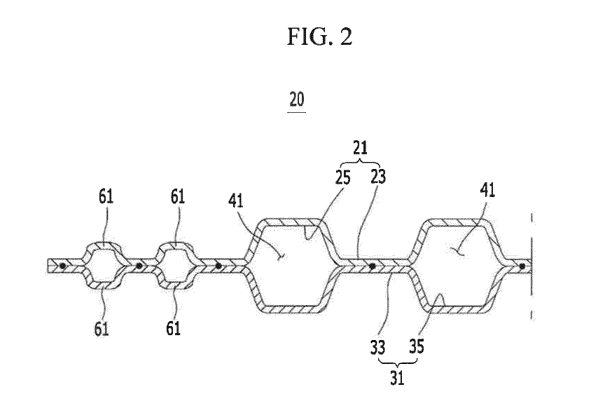

FIG. 2 is a cross-sectional configuration diagram illustrating the metal separator applied to the fuel cell stack according to the exemplary embodiment of the present invention. Referring to FIGS. 1 and 2, one or more curved portions 61, which are symmetrical to each other, are included around the welded portion of the first and second metal plates 21 and 31 in the exemplary embodiment of the present invention. Additionally, a plurality of curved portions 61 are formed at edge portions of the reaction surfaces of the first and second metal plates 21 and 31.

Here, the curved portions 61 may be formed so as to be curved in a direction of the membrane-electrode assembly 10 at the edge portions of the reaction surfaces of the first and second metal plates 21 and 31. For example, the curved portions 61 are formed so as to be spaced apart from each other at a predetermined interval, and may be formed as beads protruding from the cooling surfaces of the first and second metal plates 21 and 31 in a direction of recesses of the cooling channels 25 and 35 at the edge portions of the reaction surfaces of the first and second metal plates 21 and 31.

In this case, at the edge portions of the reaction surfaces of the first and second metal plates 21 and 31, regions between the curved portions 61 may be coupled to each other by the aforementioned laser welding. Accordingly, in the exemplary embodiment of the present invention, the metal separator 20 for the fuel cell may be formed by welding the external regions of the cooling channels 25 and 35 when the cooling surfaces of the first and second metal plates 21 and 31 are in close contact with each other.

Further, in the exemplary embodiment of the present invention, the metal separator 20 for the fuel cell may be formed by forming the curved portions 61, which are symmetrical to each other, at the edge portions of the first and second metal plates 21 and 31, and welding the regions between the curved portions 61. Accordingly, in the exemplary embodiment of the present invention, the cooling surfaces of the first and second metal plates 21 and 31 are welded, and the curved portions 61 curved toward the membrane-electrode assembly 10 are formed at the edge portions of the reaction surfaces of the first and second metal plates 21 and 31, so that it is possible to further improve air-tightness of the cooling surfaces and the reaction surfaces of the metal separator 20 for the fuel cell.

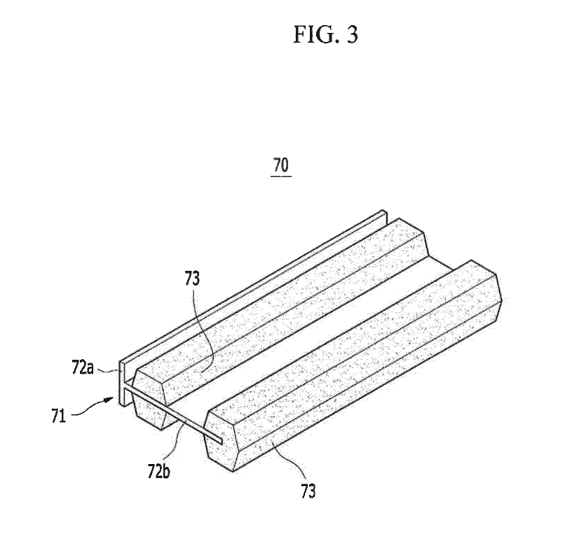

FIG. 3 is a partially cut perspective view illustrating the gasket assembly applied to the fuel cell stack according to the exemplary embodiment of the present invention. Referring to FIGS. 1 and 3, the gasket assembly 70 according to the exemplary embodiment of the present invention has the purpose of maintaining air-tightness between the edge portions of the first and second metal plates 21 and 31 of the metal separator 20 for the fuel cell and the membrane-electrode assembly 10 as mentioned above. The gasket assembly 70 may be installed between the metal plates 21 and 31 and the membrane-electrode assembly 10 with the curved portion 61 interposed between the first and second metal plates 21 and 31.

More specifically, the gasket assembly 70 may include a frame 71 formed of an insulation material, and gaskets 73 integrally injection molded with the frame 71. The frame 71 may include a first portion 72a disposed in a stack direction of the fuel cells 50, and a second portion 72b connected to the first portion 72a in a vertical direction. The first portion 72a is erected in the stack direction of the fuel cells 50, and the second portion 72b may be connected to a center of the first portion 72a in a horizontal direction. That is, the frame 71 may have a cross-section shaped like a letter “T”.

Further, the gaskets 73 may be injection molded in upper and lower surfaces of the second portion 72b of the frame 71, and may be disposed between the curved portions 61 of the metal plates 21 and 31 between the edge portions of the first and second metal plates 21 and 31 and the membrane-electrode assembly 10. In this case, at least one side surface of the gasket 73 may be in close contact with the curved portion 61 of the metal separator 20, and be compressed by the metal separator 20 when the fuel cells are coupled, and have a shape corresponding to a shape of the curved portion 61.

According to the fuel cell stack 100 according to the exemplary embodiment of the present invention having the aforementioned configuration, it is possible to maintain air-tightness of the fuel cells 50 by separately forming the gasket assembly 70 by a method of injection molding the gasket 73 to the frame 71, and interposing the gasket assembly 70 between the edge portions of the first and second metal plates 21 and 31 of the metal separator 20 and the membrane-electrode assembly 10.

Further, in the exemplary embodiment of the present invention, the gasket assembly 70 is separately formed, so that it is possible to further improve rigidity and air-tightness of the fuel cells 50, prevent deformation, surface contamination, and the like of the metal separator 20 present in the related art, while at the same time reducing failure of the metal separator 20, and further improving productivity of the entire stack 100.

Further, in the exemplary embodiment of the present invention, the frame 71 of the gasket assembly 70 may serve as a stopper when the fuel cells 50 are stacked, so that it is possible to achieve external insulation of the metal separator 20 and uniformity of a length of the stack.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

| | | | |
|---|---|---|---|
| 1 | Electricity generation assembly | | |
| 10 | Membrane-electrode assembly | | |
| 20 | Metal separator for fuel cell | 21 | First metal plate |
| 23 | First reaction gas channel | 25, 35 | Cooling channel |
| 31 | Second metal plate | | |
| 33 | Second reaction gas channel | | |
| 41 | Cooling passage | 50 | Fuel cell |
| 61 | Curved portion | 70 | Gasket assembly |
| 71 | Frame | 72a | First portion |
| 72b | Second portion | 73 | Gasket |

What is claimed is:

1. A metal separator for a fuel cell disposed on both sides of a membrane-electrode assembly (MEA),
wherein the metal separator for the fuel cell is formed of:
first and second metal plates welded together, the first and second plates initially separated from each other, and
one or more curved portions, which are symmetrical to each other, formed around a welded portion of the first and second metal plates.

2. The metal separator of claim 1, wherein:
one surface of the first metal plate is formed as a reaction surface having a first reaction gas channel, and the other surface is formed as a cooling surface having a cooling channel,
one surface of the second metal plate is formed as a reaction surface having a second reaction gas channel, and the other surface is formed as a cooling surface having a cooling channel,
a cooling passage formed by unified cooling channels while the cooling surfaces of the first and second metal plates are welded to each other is formed between the first and second metal plates, and
the curved portion is formed so as to curve toward the membrane-electrode assembly at edge portions of the reaction surfaces of the first and second metal plates.

3. The metal separator of claim 2, wherein:
a plurality of curved portions are formed at the edge portions of the reaction surfaces of the first and second metal plates, and
in the edge portions of the reaction surfaces of the first and second metal plates, regions between the curved portions are welded to each other.

4. A fuel cell stack making up an electricity generation assembly by stacking a plurality of fuel cells in which the metal separator of claim 1 is in close contact with both sides of a membrane-electrode assembly, the fuel cell stack comprising:
a gasket assembly interposed between the membrane-electrode assembly and an edge portion of the metal separator,
wherein the metal separator is formed of a first metal plate and a second metal plate welded to each other, and one or more curved portions, which are symmetrical to each other, formed around a welded portion of the first and second metal plates, and
the gasket assembly is installed between the membrane-electrode assembly and the edge portion of the metal separator with the curved portion therebetween.

5. The fuel cell stack of claim 4, wherein: the gasket assembly includes a frame formed of an insulation material, and a gasket integrally injection molded with the frame.

6. The fuel cell stack of claim 5, wherein a plurality of the curved portions are included at the edge portions of the first and second metal plates, and the gasket is disposed between the curved portions.

7. The fuel cell stack of claim 6, wherein regions between the curved portions in edge portions of reaction surfaces of the first and second metal plates are welded to each other.

8. A gasket assembly of a fuel cell stack making up an electricity generation assembly by stacking a plurality of fuel cells in which the metal separator of claim 1 is in close contact with both sides of a membrane-electrode assembly, the gasket assembly being interposed between the membrane-electrode assembly and an edge portion of the metal separator, the gasket assembly comprising:
a frame formed of an insulation material and gaskets integrally injection molded with both surfaces of the frame, wherein at least one side surface of the gasket is in close contact with a curved portion of the metal separator, compressed when the fuel cell stack is coupled, and has a shape corresponding to a shape of the curved portion.

9. The gasket assembly of claim 8, wherein the frame includes a first portion disposed in a stack direction of the fuel cells, and a second portion connected with the first portion in a vertical direction.

10. The gasket assembly of claim 9, wherein the frame has a cross-section shaped in the shape of a letter “T”.

11. The gasket assembly of claim 9, wherein the gaskets are injection molded on upper and lower surfaces of the second portion.

12. The gasket assembly of claim 8, wherein the gasket is disposed between the membrane-electrode assembly and the edge portion of the metal separator with the curved portion formed at the edge portions of the first and second metal plates therebetween in the metal separator in which a first metal plate and a second metal plate are welded to each other.

13. A fuel cell vehicle, comprising:
a fuel cell stack which includes metal separators in close contact with both sides of a membrane-electrode assembly, the fuel cell stack including:
a gasket assembly interposed between the membrane-electrode assembly and an edge portion of the metal separator,
wherein the metal separator is formed of a first metal plate and a second metal plate welded to each other, and one or more curved portions, which are symmetrical to each other, formed around a welded portion of the first and second metal plates, and
the gasket assembly is installed between the membrane-electrode assembly and the edge portion of the metal separator with the curved portion therebetween.

14. The fuel cell vehicle of claim 13, wherein: the gasket assembly includes a frame formed of an insulation material, and a gasket integrally injection molded with the frame.

15. The fuel cell vehicle of claim 14, wherein a plurality of the curved portions are included at the edge portions of the first and second metal plates, and the gasket is disposed between the curved portions.

16. The fuel cell vehicle of claim 15, wherein regions between the curved portions in edge portions of reaction surfaces of the first and second metal plates are welded to each other.
